(19) United States
(12) Patent Application Publication
(10) Pub. No.: US 2020/0304673 A1
(43) Pub. Date: Sep. 24, 2020

(54) IMAGE PROCESSING SYSTEM, IMAGE PROCESSING APPARATUS, CONTROL PROGRAM FOR IMAGE PROCESSING APPARATUS, INFORMATION PROCESSING APPARATUS, CONTROL PROGRAM FOR INFORMATION PROCESSING APPARATUS, AND CONTROL PROGRAM FOR TERMINAL

(71) Applicant: Konica Minolta Inc., Tokyo (JP)

(72) Inventor: Kazumi SAWAYANAGI, Itami-shi (JP)

(21) Appl. No.: 16/777,396

(22) Filed: Jan. 30, 2020

(30) Foreign Application Priority Data
Mar. 20, 2019 (JP) 2019-053126

(51) Int. Cl. H04N 1/00; G06F 21/56

(52) U.S. Cl. CPC H04N 1/00896; G06F 21/567; H04N 2201/0094; G06F 2221/031; G06F 21/562

(57) ABSTRACT

An image processing system includes: an image processing apparatus that has a virus scan function; a terminal; and an information processing apparatus that has a virus scan function, the image processing apparatus, the terminal, and the information processing apparatus communicating with each other, wherein the image processing apparatus includes: a first hardware processor that: transmits to the terminal information identifying the image processing apparatus and a virus scan substitute request for the job data for executing a virus scan in the information processing apparatus; and causes returning from the power saving state to the normal state, and the information processing apparatus includes: a second hardware processor that: performs the virus scan on the job data; and transmits, to the image processing apparatus, the execution instruction for the job related to the job data with the predetermined information added.

The entire disclosure of Japanese patent Application No. 2019-053126, filed on Mar. 20, 2019, is incorporated herein by reference in its entirety.

### BACKGROUND

### Technological Field

The present invention relates to an image processing system, an image processing apparatus, a control program for an image processing apparatus, an information processing apparatus, a control program for an information processing apparatus, and a control program for a terminal More specifically, the present invention relates to an image processing system, an image processing apparatus, a control program for an image processing apparatus, an information processing apparatus, a control program for an information processing apparatus, and a control program for a terminal capable of suppressing a decrease in reliability of virus scans and a decrease in the power saving effect of the image processing apparatus.

### Description of the Related Art

Electrophotographic image forming devices include multi function peripherals (MFPs), facsimile machines, copiers, and printers that have a scanner function, a facsimile function, a copying function, a printer function, a data communication function, and a server function.

In recent years, image processing apparatuses such as MFPs are provided with a virus scan function to respond to the growing demand for addressing security risks in offices. When a job such as a print job is received from an external device, an image processing apparatus having a virus scan function performs a virus scan on job data before executing the job.

Note that conventional virus scan techniques are disclosed in JP 2006-41740 A and JP 2006-277004 A. JP 2006-41740 A discloses an image forming system including an MFP serving as a multi-function copier and an external device. The external device constantly monitors access from a network and detect viruses. When a virus is detected, the external device notifies the MFP of the detection of the virus via a communication line, and requests the MFP to perform notification with a predetermined notification method. The MFP shows that a virus has been detected by, for example, printing information on the detected virus on a sheet.

JP 2006-277004 A discloses a device management server that manages a plurality of printers connected to a network and performs output processing to a printer in response to a request from a client. A technique is disclosed in which a virus check is performed on a data file received from the client, and when a virus infection or suspicion is detected, a virus in a corresponding file is removed and/or the corresponding file is deleted.

To respond to the growing demand for reduction in power consumption, in recent years, image processing apparatuses such as MFPs are provided with a sleep function (a function for shifting to a power saving state, in which power consumption is low, in a predetermined case). When an image processing apparatus having a virus scan function and a sleep function receives a job from an external device in a power saving state, it returns to a normal state from the power saving state before performing a virus scan on the job data, and then performs the virus scan on the job data. As a result, as compared with an image processing apparatus having no virus scan function, there is a problem in that the time in the power saving state is shortened by the time during which the virus scan is being performed, and the power saving effect is reduced accordingly.

As a method that can suppress a decrease in the power saving effect of the image processing apparatus, a method is also conceivable in which a terminal that is a transmitter performs a virus scan on job data before transmitting a job to the image processing apparatus. However, in general, the terminal is owned by the user and is under control of the user. For this reason, there may be a situation where the update of a definition file for the virus scan function of the terminal is delayed and the version of the definition file is old, or the terminal fails to execute a virus scan on the job data. In these cases, job data that may be infected with a virus is transmitted to the image processing apparatus. As a result, there is a problem in that the reliability of virus scans is lowered, and it is difficult to ensure security for an image processing system.

### SUMMARY

To solve the above-described problems, an object of the present invention is to provide an image processing system, an image processing apparatus, a control program for an image processing apparatus, an information processing apparatus, a control program for an information processing apparatus, and a control program for a terminal capable of suppressing a decrease in reliability of virus scans and a decrease in the power saving effect of the image processing apparatus.

To achieve the abovementioned object, according to an aspect of the present invention, an image processing system reflecting one aspect of the present invention comprises: an image processing apparatus that has a virus scan function; a terminal; and an information processing apparatus that has a virus scan function, the image processing apparatus, the terminal, and the information processing apparatus communicating with each other, wherein the image processing apparatus includes: a first hardware processor that: transmits to the terminal, when job data is received from the terminal in a power saving state in which power consumption is lower than in a normal state, information identifying the image processing apparatus and a virus scan substitute request for the job data for executing a virus scan in the information processing apparatus; and causes returning from the power saving state to the normal state, when an execution instruction for a job related to the job data with predetermined information added is received in the power saving state, and the information processing apparatus includes: a second hardware processor that: performs the virus scan on the job data when the information identifying the image processing apparatus and the virus scan substitute request for the job data are received from the terminal; and transmits, to the image processing apparatus, the execution instruction for the job related to the job data with the predetermined information added when no virus is detected from the job data as a result of the virus scan by the second hardware processor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram conceptually illustrating a configuration of an image processing system in one embodiment of the present invention;

FIG. 2 is a block diagram illustrating a hardware configuration of MFPs in one embodiment of the present invention;

FIG. 3 is a block diagram illustrating a hardware configuration of a server in one embodiment of the present invention;

FIG. 4 is a block diagram illustrating a hardware configuration of a terminal in one embodiment of the present invention;

FIG. 5 is a block diagram illustrating a functional configuration of the image processing system in one embodiment of the present invention;

FIG. 6 is a diagram for explaining an operation of the image processing system when the server serves as a substitute to execute a virus scan for job data received by the MFP in one embodiment of the present invention;

FIG. 7 is a diagram for explaining an operation of the image processing system when the MFP serves as a substitute to execute a virus scan for job data received by the MFP in a modification of one embodiment of the present invention;

FIG. 8 is a sequence diagram illustrating a typical operation of the image processing system in one embodiment of the present invention;

FIG. 9 is a flowchart illustrating an operation of the MFP in one embodiment of the present invention;

FIG. 10 is a flowchart illustrating an operation of the server in one embodiment of the present invention;

FIG. 11 is a flowchart illustrating an operation of the terminal in one embodiment of the present invention;

and

FIGS. 12A, 12B, and 12C are diagrams for explaining effects of one embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

In the present embodiment, a case will be described in which the image processing apparatus is an MFP and the information processing apparatus is a server or an MFP. The image processing apparatus may be an image forming apparatus other than MFPs, such as a printer, a copier, or a facsimile, or may be a display device, a personal computer (PC), a mobile phone, a smartphone, or the like. The information processing apparatus may be an image forming apparatus such as a printer, a copier, or a facsimile. The information processing apparatus may be a display device, a PC, a mobile phone, a smartphone, or the like.

[Configuration of Image Processing System]

First, a configuration of the image processing system in the present embodiment will be described.

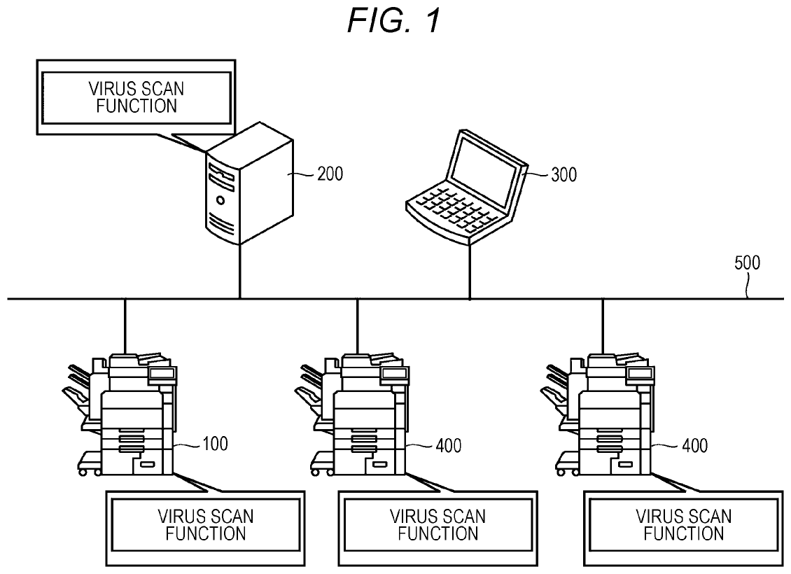

FIG. 1 is a diagram conceptually illustrating the configuration of the image processing system in one embodiment of the present invention.

Referring to FIG. 1, the image processing system according to the present embodiment includes an MFP 100 (an example of the image processing apparatus), a server 200 (an example of the information processing apparatus), a terminal 300 (an example of the terminal), and a plurality of MFPs 400. The MFP 100, the server 200, the terminal 300, and the plurality of MFPs 400 are connected to each other through a network 500 and communicate with each other.

The network 500 is a wired network or a wired local area network (LAN) or wide area network (WAN). The network 500 connects various devices using TCP/IP (Transmission Control Protocol/Internet Protocol) protocols. Devices connected to the network 500 can exchange various data with each other.

Anti-virus software is installed in each of the MFP 100, the server 200, and the plurality of MFPs 400, and each of the MFP 100, the server 200, and the MFPs 400 has a virus scan function. Each of the MFP 100, the server 200, and the MFPs 400 can detect a virus from target data by performing a virus scan on the target data.

The MFPs 100 and 400 are connected to the same local network line without passing through a wide area network line. The server 200 is a cloud server, and is connected to the local network line to which the MFPs 100 and 400 are connected via a wide area network line.

Note that the image processing system may further include an image processing apparatus, an information processing apparatus, a terminal, or the like connected to the network 500.

The terminal 300 is owned by the user. The terminal 300 can transmit a job execution instruction to each of the MFPs 100 and 400 through the network 500 by a user operation.

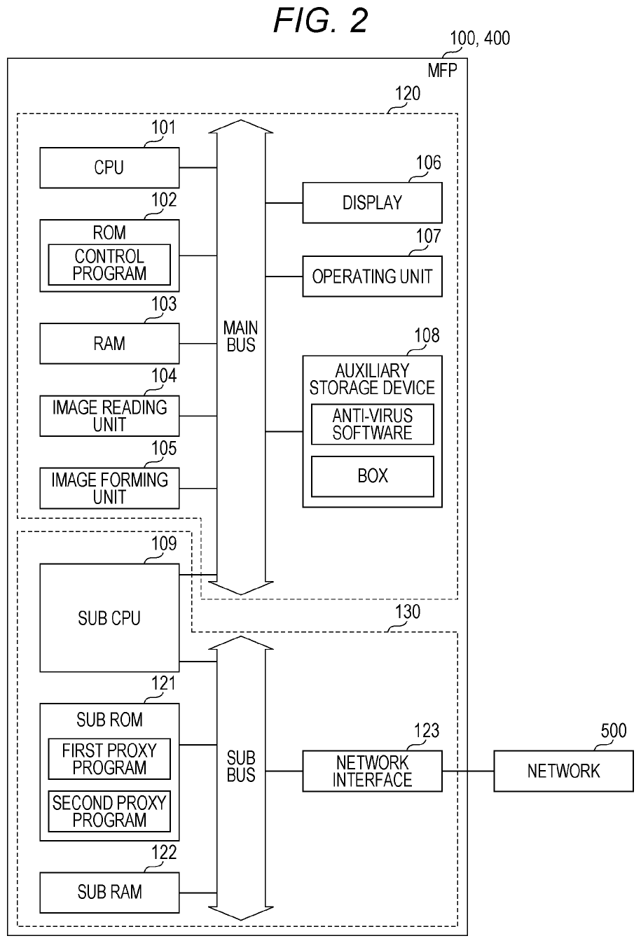

FIG. 2 is a block diagram illustrating a hardware configuration of the MFPs 100 and 400 in one embodiment of the present invention.

Referring to FIG. 2, the MFPs 100 and 400 each have the same hardware configuration. Each of the MFPs 100 and 400 includes a central processing unit (CPU) 101, a read only memory (ROM) 102, a random access memory (RAM) 103, an image reading unit 104, an image forming unit 105, a display 106, an operating unit 107, an auxiliary storage device 108, a sub CPU 109, a sub ROM 121, a sub RAM 122, and a network interface 123.

The CPU 101 is connected to each of the ROM 102, the RAM 103, the image reading unit 104, the image forming unit 105, the display 106, the operating unit 107, the auxiliary storage device 108, and the sub CPU 109 through a main bus. The sub CPU 109 is connected to each of the sub ROM 121, the sub RAM 122, and the network interface 123 through a sub bus.

The power supply state to each member of the MFPs can be switched between a normal state and a power saving state. In the normal state, power is supplied to the members surrounded by a dotted line 120 (in other words, the members connected to the main bus without being connected to the sub bus), and also to the members surrounded by a dotted line 130 (in other words, the members connected to the sub bus). The power saving state is a state in which the supply of power to the members surrounded by the dotted line 120 is stopped and the supply of power to the members surrounded by the dotted line 130 is performed. The power consumption in the power saving state is smaller than the power consumption in the normal state.

When the MFP is in the power saving state, power is not supplied to the CPU 101 and the like. Therefore, in order for the MFP in the power saving state to execute various jobs or a virus scan, it is necessary for the MFP to return from the power saving state to the normal state.

The CPU 101 controls the entire MFP 100 with respect to various jobs such as a scan job, a copy job, a mail transmission job, and a print job by executing control programs stored in the ROM 102.

The CPU 101 also performs a virus scan on target data by executing an anti-virus software program stored in the auxiliary storage device 108.

Furthermore, the CPU 101 stops the supply of power to the members surrounded by the dotted line 120 in predetermined cases (for example, when the execution of a job is finished or when operations and job execution instructions have not been accepted for a certain period of time), whereby the state of the MFP is shifted from the normal state to the power saving state.

The ROM 102 is, for example, a flash ROM. The ROM 102 stores various control programs to be executed by the CPU 101 and various fixed data.

The RAM 103 is a main memory of the CPU 101. The RAM 103 is used for temporarily storing data necessary when the CPU 101 executes a control program and image data, for example.

The image reading unit 104 reads an image of a document and generates data on the image thus read.

The image forming unit 105 performs printing on a sheet. The image forming unit 105 mainly includes a toner image forming unit, a fixing device, a sheet conveyance unit, and the like. For example, the image forming unit 105 employs electrophotography to form an image on a sheet. The toner image forming unit is of what is known as a tandem type that forms a color image on a sheet by combining four color images. The toner image forming unit includes photosensitive members provided for respective colors of C (cyan), M (magenta), Y (yellow), and K (black), an intermediate transfer belt onto which toner images are transferred (primary transfer) from the photosensitive members, a transfer unit that transfers (secondary transfer) the images onto a sheet from the intermediate transfer belt, and the like. The fixing device has a heating roller and a pressing roller. In the fixing device, the heating roller and the pressing roller nip and convey the sheet on which the toner images have been formed, while applying heat and pressure to the sheet. In this manner, the fixing device melts the toner attached to the sheet and fixes it on the sheet, whereby an image is formed on the sheet. The sheet conveyance unit conveys the sheet along a conveyance path inside the MFP casing. Furthermore, the sheet conveyance unit discharges the sheet on which the image has been formed, from the MFP casing to a sheet discharge tray or the like.

The display 106 displays various types of information.

The operating unit 107 receives various operations.

The auxiliary storage device 108 stores various types of information. In particular, the auxiliary storage device 108 stores an anti-virus software program and a virus definition file. The auxiliary storage device 108 includes a box area that is a storage area allocated to the user of the MFP.

The sub CPU 109 communicates with devices on the network 500 by controlling the network interface 123. The sub CPU 109 executes a control program stored in the sub ROM 121. Furthermore, the sub CPU 109 causes the MFP to return from the power saving state to the normal state by initiating the supply of power to the members surrounded by the dotted line 120 in predetermined cases. The processing speed of the sub CPU 109 is lower than the processing speed of the CPU 101.

The sub ROM 121 is, for example, a flash ROM. The sub ROM 121 stores various control programs to be executed by the sub CPU 109 and various fixed data. In particular, the sub ROM 121 stores first and second proxy programs.

The sub RAM 122 is a main memory of the sub CPU 109. The sub RAM 122 is used for temporarily storing data required when the sub CPU 109 executes a control program, image data, and the like. The storage area capacity of the sub RAM 122 is smaller than the storage area capacity of the RAM 103.

The network interface 123 communicates with devices on the network 500 using a communication protocol such as TCP/IP according to an instruction from the sub CPU 109.

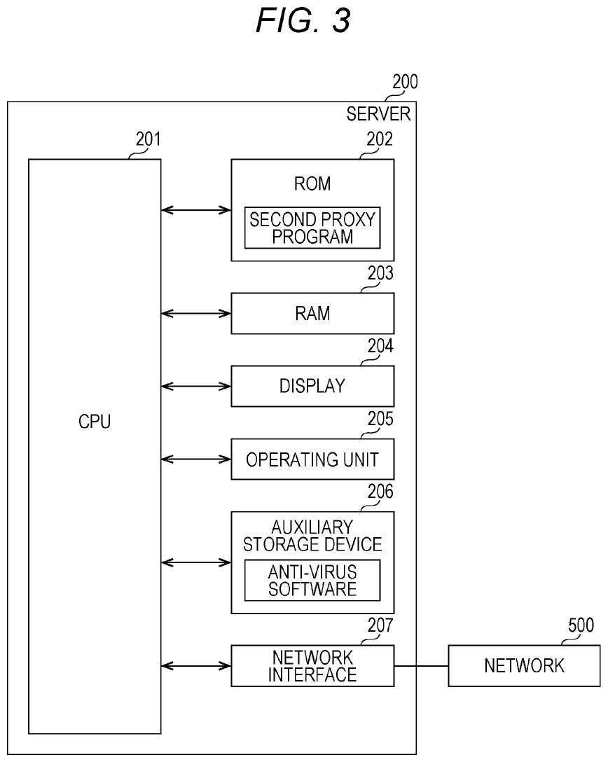

FIG. 3 is a block diagram illustrating a hardware configuration of the server 200 in one embodiment of the present invention.

Referring to FIG. 3, the server 200 includes a CPU 201, a ROM 202, a RAM 203, a display 204, an operating unit 205, an auxiliary storage device 206, and a network interface 207. The CPU 201 and each of the ROM 202, the RAM 203, the display 204, the operating unit 205, the auxiliary storage device 206, and the network interface 207 are connected to each other.

The CPU 201 controls the entire server 200 by executing a control program stored in the ROM 202. The CPU 201 also performs a virus scan on target data by executing an anti-virus software program stored in the auxiliary storage device 206.

The ROM 202 is, for example, a flash ROM. The ROM 202 stores various control programs to be executed by the CPU 201 and various fixed data. In particular, the ROM 202 stores the second proxy program.

The RAM 203 is a main memory of the CPU 201. The RAM 203 is used for temporarily storing data necessary when the CPU 201 executes a control program and the like.

The display 204 displays various information.

The operating unit 205 receives various operations.

The auxiliary storage device 206 stores various data such as an anti-virus software program and a virus definition file.

The network interface 207 communicates with devices on the network 500 using a communication protocol such as TCP/IP according to an instruction from the CPU 201.

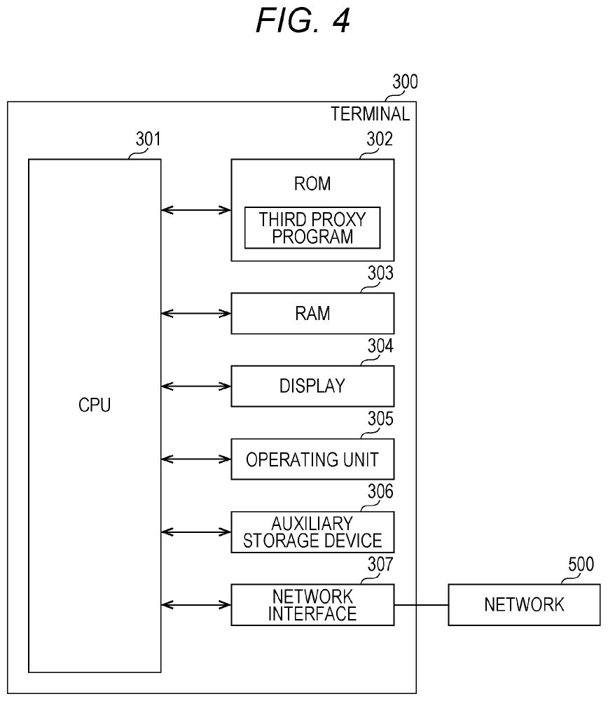

FIG. 4 is a block diagram illustrating a hardware configuration of the terminal 300 in one embodiment of the present invention.

Referring to FIG. 4, the terminal 300 is, for example, a smartphone, a mobile phone, a laptop PC, a tablet PC, or the like. The terminal 300 includes a CPU 301, a ROM 302, a RAM 303, a display 304, an operating unit 305, an auxiliary storage device 306, and a network interface 307. The CPU 301 and each of the ROM 302, the RAM 303, the display 304, the operating unit 305, the auxiliary storage device 306, and the network interface 307 are connected to each other.

The CPU 301 controls the entire terminal 300 by executing a control program stored in the ROM 302.

The ROM 302 is, for example, a flash ROM. The ROM 302 stores various control programs to be executed by the CPU 301 and various fixed data. In particular, the ROM 302 stores a third proxy program. The third proxy program may be a part of a printer driver program installed in the terminal 300.

The RAM 303 is a main memory of the CPU 301. The RAM 303 is used for temporarily storing data necessary when the CPU 301 executes a control program and the like.

The display 304 displays various information.

The operating unit 305 receives various operations.

The auxiliary storage device 306 stores various data such as software for generating job data.

The network interface 307 wirelessly communicates with devices on the network 500 using a communication protocol such as TCP/IP according to an instruction from the CPU 301.

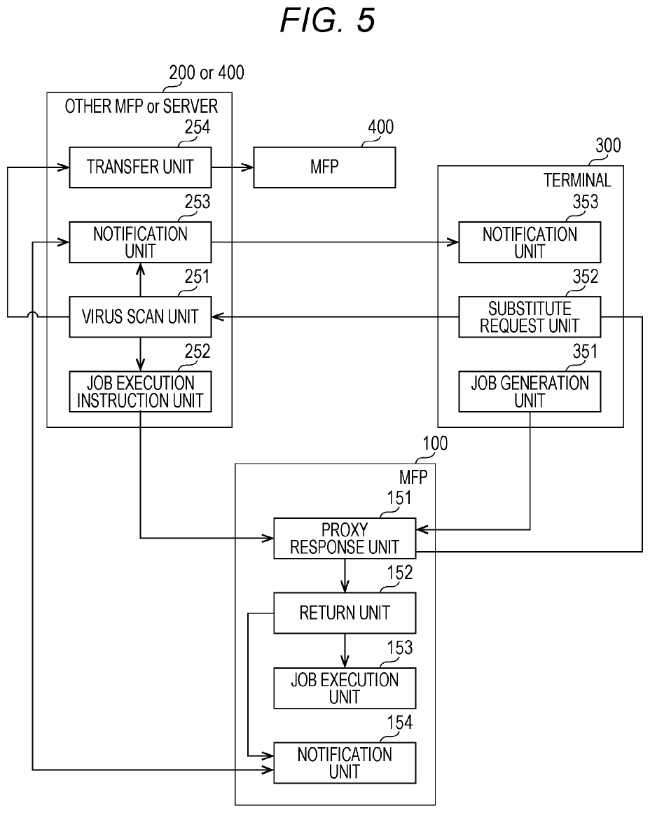

FIG. 5 is a block diagram illustrating a functional configuration of the image processing system in one embodiment of the present invention.

Referring to FIG. 5, the MFP 100 includes a proxy response unit 151 (an example of the request transmitter), a return unit 152 (an example of the returner), a job execution unit 153 (an example of the executer), and a notification unit 154 (an example of the third notifier and the inquirer). The proxy response unit 151 and the return unit 152 are implemented when the sub CPU 109 of the MFP 100 executes the first proxy program stored in the sub ROM 121 of the MFP 100. The job execution unit 153 and the notification unit 154 are implemented when the CPU 101 of the MFP 100 executes the first proxy program stored in the sub ROM 121 of the MFP 100.

When the MFP 100 receives a job execution instruction (the job execution instruction including job data) from the terminal 300 while the MFP 100 is in the power saving state, the proxy response unit 151 makes a proxy response (a process executed by the sub CPU 109 on behalf of the CPU 101 without power supply (deactivated)). Specifically, when the MFP 100 receives a job execution instruction including job data from the terminal 300 while the MFP 100 is in the power saving state, the proxy response unit 151 transmits to the terminal 300, an IP address of the MFP 100 that is information for identifying the MFP 100 and a virus scan substitute request on the job data in the server 200 (the IP address of the server 200).

When receiving a job execution instruction related to job data with predetermined information added while the MFP 100 is in the power saving state, the return unit 152 makes the MFP 100 return from the power saving state to the normal state.

When the returning from the power saving state to the normal state occurs due to the reception of the job execution instruction with predetermined information added, the job execution unit 153 executes the job related to the job data without performing a virus scan on the job data after the returning.

The notification unit 154 makes an inquiry to the server 200 when a job including job data is received from the terminal 300 while the MFP 100 is in the power saving state and when the returning from the power saving state to the normal state occurs before an execution instruction for the job with predetermined information added is received from the server 200. When being notified of a virus scan result from the server 200 in response to the inquiry, the notification unit 154 notifies the user of the virus scan result on the MFP 100 (for example, by displaying the result on the display 106).

Each of the server 200 and the plurality of MFPs 400 includes a virus scan unit 251 (an example of the scanner), a job execution instruction unit 252 (an example of the instructor), a notification unit 253 (an example of the first, second, and fourth notifiers and the return requester), and a transfer unit 254 (an example of the transferrer). Each of the virus scan unit 251, the job execution instruction unit 252, the notification unit 253, and the transfer unit 254 is implemented when the CPU 201 executes the second proxy program stored in the ROM 202. Each of the virus scan unit 251, the job execution instruction unit 252, and the notification unit 253 is implemented when the CPU 101 of the MFP 400 executes the second proxy program stored in the ROM 102 of the MFP 400.

The virus scan unit 251 performs a virus scan on job data when receiving the IP address of the MFP 100 and a virus scan substitute request for the job data from the terminal 300.

When no virus is detected from the job data as a result of the virus scan, the job execution instruction unit 252 transmits a job execution instruction related to job data with predetermined information added, to the MFP 100.

When a virus is detected from the job data as a result of the virus scan by the virus scan unit 251, the notification unit 253 notifies the terminal 300 of the detection of the virus from the job data. In addition, when a virus is detected from the job data as a result of the virus scan by the virus scan unit 251, the notification unit 253 notifies the MFP 100 of the virus scan result when receiving an inquiry from the MFP 100.

When a virus is detected from job data as a result of the virus scan by the virus scan unit 251, but the terminal 300 cannot be notified of the detection of the virus from the job data, the notification unit 253 transmits a request (return request) for returning from the power saving state to the normal state to the MFP 100, and notifies the MFP 100, having returned to the normal state, of the detection of the virus from the job data.

When the IP address of the MFP 100 and the virus scan substitute request for the job data are received from the terminal 300, while the virus scan unit 251 is executing a virus scan on another job data, the transfer unit 254 transfers the IP address of the MFP 100 and the virus scan substitute request for the job data to an apparatus (such as the MFP 400) having a virus scan function other than the host apparatus.

The terminal 300 includes a job generation unit 351, a substitute request unit 352 (an example of the substitute requester), and a notification unit 353. Each of the job generation unit 351, the substitute request unit 352, and the notification unit 353 is implemented when the CPU 301 executes the third proxy program stored in the ROM 302.

The job generation unit 351 generates a job including job data in response to a user operation, and transmits the generated job (an execution instruction for the generated job) to the MFP 100.

When receiving the IP address of the MFP 100 and the virus scan substitute request for the job data in the server 200 from the MFP 100, the substitute request unit 352 transmits the IP address of the MFP 100 to the server 200 and requests the server 200 to serve as a substitute to execute a virus scan on the job data.

When being notified of the detection of a virus from job data from the server 200, the notification unit 353 notifies the user of the detection of the virus from the job data on the terminal 300 (for example, by displaying the fact on the display unit 304).

[Operation of Image Processing System]

Next, an operation of the image processing system in the present embodiment will be described. Here, a case will be described in which the server 200 serves as a substitute to execute a virus scan for job data received by the MFP 100.

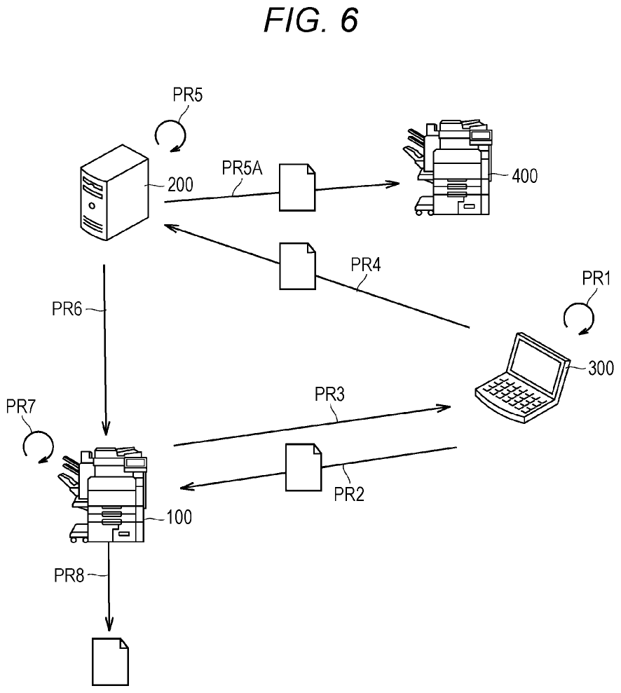

FIG. 6 is a diagram for explaining an operation of the image processing system when the server 200 serves as a substitute to execute a virus scan for the job data received by the MFP 100 in one embodiment of the present invention.

Referring to FIG. 6, the terminal 300 generates a job including job data in response to a user operation (process PR1). The job generated by the terminal 300 may be any type of job that can be executed by the MFP 100. Still, the job is preferably a job that involves storing data in the MFP 100 (such as a print job for printing job data or a box storage job for storing job data in the auxiliary storage device 108). Here, it is assumed that the job generated is a print job. The terminal 300 transmits an execution instruction for the generated print job to the MFP 100 (process PR2).

When receiving the execution instruction for the print job in the normal state, the MFP 100 executes a virus scan on job data related to the print job. The MFP 100 executes a print job when no virus is detected from the job data as a result of virus scan.

On the other hand, when receiving the print job execution instruction from the MFP 100 while being in the power saving state, the MFP 100 does not return from the power saving state to the normal state, and executes no virus scan on the job data related to the print job. The MFP 100 makes a proxy response. Specifically, the MFP 100 transmits a virus scan substitute request on the job data in the server 200 to the terminal 300. In addition to the substitute request, the MFP 100 transmits to the terminal 300 its own IP address (IP address of the MFP 100) and the IP address of the server 200, which is information for identifying the substitute to execute a virus scan (process PR3).

When receiving the IP address of the MFP 100 and the virus scan substitute request from the MFP 100, the terminal 300 transmits the virus scan substitute request for the job data to the server 200 together with the job data. In addition to the substitute request, the terminal 300 transmits the IP address of the MFP 100, which is the request source of the substitute request, to the server 200 (process PR4).

The server 200 executes a virus scan on the job data when receiving the IP address of the MFP 100 and a virus scan substitute request for the job data from the terminal 300 (process PR5).

When no virus is detected from the job data as a result of the virus scan, the server 200 transmits an execution instruction for a print job related to the job data to the MFP 100, which is the request source of the substitute request. The IP address of the server 200, which is information for identifying the host apparatus, is added to this execution instruction for the print job (process PR6).

The MFP 100 returns from the power saving state to the normal state, when the execution instruction for a print job is received while being in the power saving state and when the IP address of the server 200, which is the substitute to execute the virus scan, is added to the execution instruction for the print job (process PR7). Then, after returning to the normal state, the MFP 100 executes a print job related to the job data without performing a virus scan on the job data (process PR8).

As a modification of the above operation, the image processing system may operate as at least one of the following (1) to (4).

(1) The process PR4 may be a process performed through a user operation instead of the process executed by the CPU 301 of the terminal 300 based on the third proxy program. Specifically, when the terminal 300 receives the IP address of the MFP 100 and the virus scan substitute request from the MFP 100, the terminal 300 notifies the user of the reception. The user may transmit, through user's own operation, a virus scan substitute request for job data to the server 200 together with the job data, and to transmit the IP address of the MFP 100, which is the request source of the substitute request, to the server 200 together with the substitute request.

(2) The server 200 that serves as a substitute to execute a virus scan may be executing a virus scan on another job data, at the point of reception of the IP address of the MFP 100 and a virus scan substitute request on job data from the terminal 300. In such a case, instead of performing the process PR5 (instead of performing a virus scan), the server 200 may transfer the IP address of the MFP 100 and a virus scan substitute request on the job data to another apparatus (such as the MFP 400) having a virus scan function other than the MFP 100 (process PR5A). Then, the apparatus that has received the IP address and the substitute request transferred serves as a substitute to execute the subsequent process of the server 200. As a result, a virus scan can be swiftly executed.

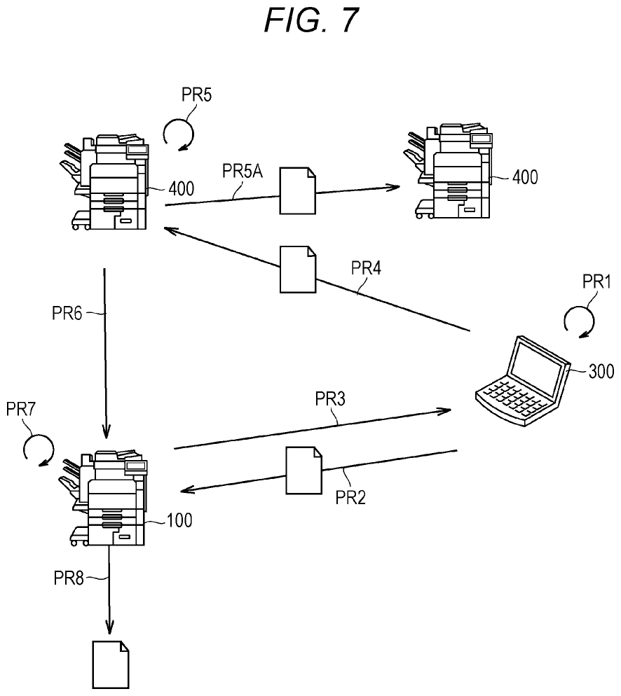

(3) The substitute to execute virus scan on the job data received by the MFP 100 may be any apparatus having a virus scan function other than the MFP 100. Thus, the substitute may be another image processing apparatus (such as the MFP 400 (an example of the information processing apparatus)) other than the MFP 100, instead of the server 200. FIG. 7 is a diagram for explaining an operation of the image processing system when the MFP 400 serves as a substitute to execute a virus scan for the job data received by the MFP 100.

(4) In the process PR6, when no virus is detected from the job data as a result of the virus scan, information indicating the completion of the virus scan may be added to the print job execution instruction transmitted by the server 200, instead of the information (the IP address of the server 200) for identifying the server 200. Furthermore, in the process PR3, when receiving the print job execution instruction with no information indicating the completion of the virus scan added while being in the power saving state, the MFP 100 may make a proxy response without returning to the normal state from the power saving state. In the process PR7, the MFP 100 may return to the normal state from the power saving state when receiving the print job execution instruction with the information indicating the completion of the virus scan added while being in the power saving state.

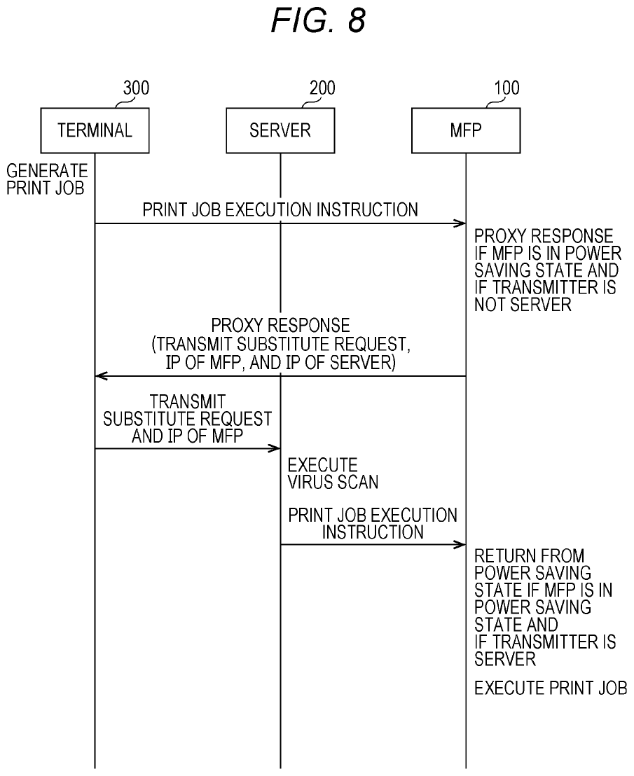

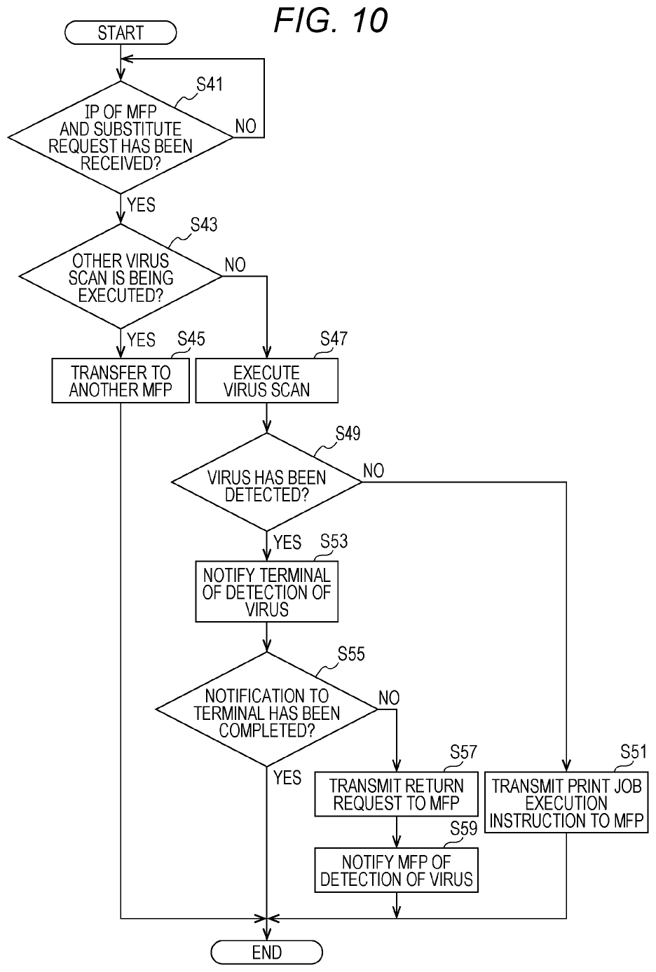

FIG. 8 is a sequence diagram illustrating a typical operation of the image processing system in one embodiment of the present invention. Although the substitute to execute a virus scan is the server 200 in the description with reference to FIG. 8 and FIG. 10, the substitute to execute a virus scan may be the MFP 400.

Referring to FIG. 8, upon generating a print job, the terminal 300 transmits an execution instruction for the generated print job to the MFP 100.

When the MFP 100 is in the power saving state and the transmitter of the print job is not a virus scan substitute (server 200), the MFP 100 makes a proxy response to the terminal 300. Specifically, the MFP 100 transmits a virus scan substitute request, the IP address of the MFP 100, and the IP address of the server 200 to the terminal 300.

Upon receiving the substitute request, the terminal 300 transmits a virus scan substitute request including the IP address of the MFP 100 to the server 200.

The server 200 performs a virus scan on job data when receiving the virus scan substitute request from the terminal 300. When no virus is detected from the job data as a result of the virus scan, the server 200 transmits an execution instruction for a print job related to the job data to the MFP 100.

When the MFP 100 is in the power saving state and the transmitter of the print job is a virus scan substitute, the MFP 100 returns from the power saving state to the normal state and performs a print job of the job data.

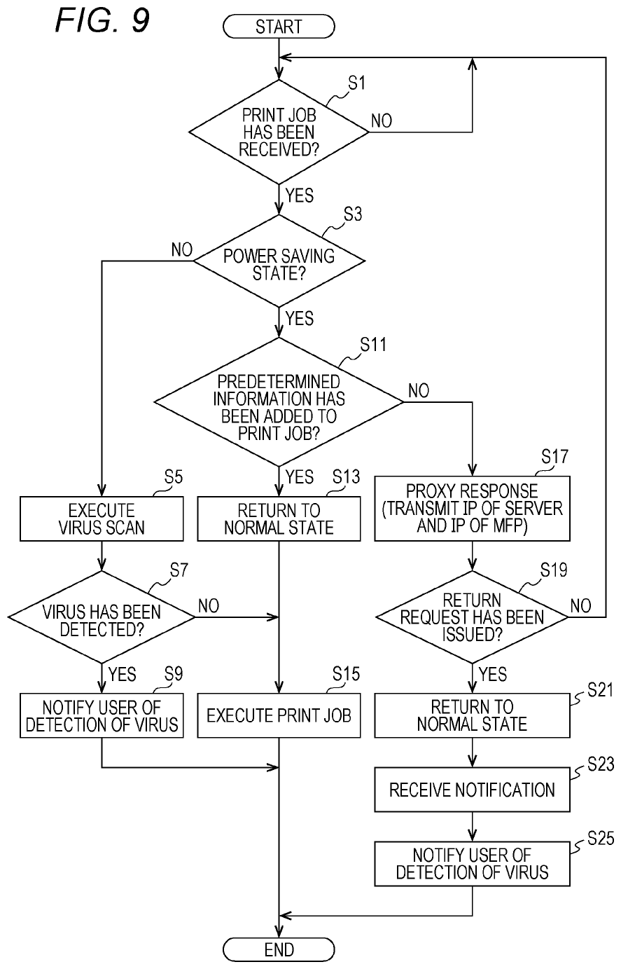

FIG. 9 is a flowchart illustrating an operation of the MFP 100 in one embodiment of the present invention.

Referring to FIG. 9, the sub CPU 109 of the MFP 100 determines whether a print job has been received (S1). The CPU 101 repeats the process in step S1 until it is determined that a print job has been received.

When it is determined in step S1 that a print job has been received (YES in S1), the sub CPU 109 determines whether the host apparatus is in the power saving state (S3).

When it is determined in step S3 that the host apparatus is not in the power saving state (NO in S3), the CPU 101 performs a virus scan on the job data related to the print job (S5), and determines whether a virus has been detected from the job data (S7).

When it is determined in step S7 that a virus is detected from the job data (YES in S7), the CPU 101 notifies the user of the detection of the virus through the terminal 300 or the display 106 of the host apparatus (S9) and ends the process.

When it is determined in step S7 that no virus is detected from the job data (NO in S7), the CPU 101 executes the print job (S15) and ends the process.

When it is determined in step S3 that the host apparatus is in the power saving state (YES in S3), the sub CPU 109 determines whether predetermined information (the IP address of the server 200 or information indicating the completion of a virus scan) is added to the print job (S11).

When it is determined in step S11 that the predetermined information is added to the print job (YES in S11), the sub CPU 109 returns from the power saving state to the normal state (S13). After the return, the CPU 101 executes the print job (S15) and ends the process.

When it is determined in step S11 that the predetermined information is not added to the print job (NO in S11), the sub CPU 109 makes a proxy response and transmits a virus scan substitute request, the IP address of the MFP 100, and the IP address of the server 200 to the terminal 300 (S17). Next, the sub CPU 109 determines whether a return request has been received from the server 200 (S19).

When it is determined in step S19 that no return request is received from the server 200 (NO in S19), the sub CPU 109 proceeds to the process of step S1.

When it is determined in step S19 that a return request has been received from the server 200 (YES in S19), the sub CPU 109 returns from the power saving state to the normal state (S21). After the return, the CPU 101 receives from the server 200 a notification that the virus has been detected from the job data (S23). The CPU 101 notifies the user of the detection of a virus from the job data through the display 106 (S25), and ends the process.

FIG. 10 is a flowchart illustrating an operation of the server 200 in one embodiment of the present invention.

Referring to FIG. 10, the CPU 201 determines whether the IP address of MFP 100 and a virus scan substitute request for job data have been received from the terminal 300 (S41). The CPU 201 repeats the process in step S41 until it is determined that the IP address of the MFP 100 and the virus scan substitute request for the job data have been received from the terminal 300.

When it is determined in step S41 that the IP address of the MFP 100 and the virus scan substitute request for the job data have been received from the terminal 300 (YES in S41), the CPU 201 determines whether a virus scan is being executed on another job data (S43).

When it is determined in step S43 that a virus scan is being executed on another job data (YES in S43), the CPU 201 transfers the IP address of the MFP 100 and the virus scan substitute request for the job data to the MFP 400 (S45), and ends the process.

When it is determined in step S43 that a virus scan is not being executed on another job data (NO in S43), the CPU 201 executes a virus scan on the job data (S47) and determines whether a virus is detected from the job data (S49).

When it is determined in step S49 that no virus is detected from the job data (NO in S49), the CPU 201 transmits a print job execution instruction related to the job data with predetermined information added, to the MFP 100 (S51), and ends the process.

When it is determined in step S49 that a virus has been detected from the job data (YES in S49), the CPU 201 notifies the terminal 300 of the detection of the virus from the job data (S53). Subsequently, the CPU 201 determines whether the notification to the terminal 300 has been completed (S55).

When it is determined in step S55 that the notification to the terminal 300 has been completed (YES in S55), the CPU 201 ends the process.

When it is determined in step S55 that the notification to the terminal 300 has not been completed (NO in S55), the CPU 201 transmits a return request to the MFP 100 (S57). After the MFP 100 returns to the normal state, the CPU 201 notifies the MFP 100 of the detection of the virus from the job data (S59), and ends the process.

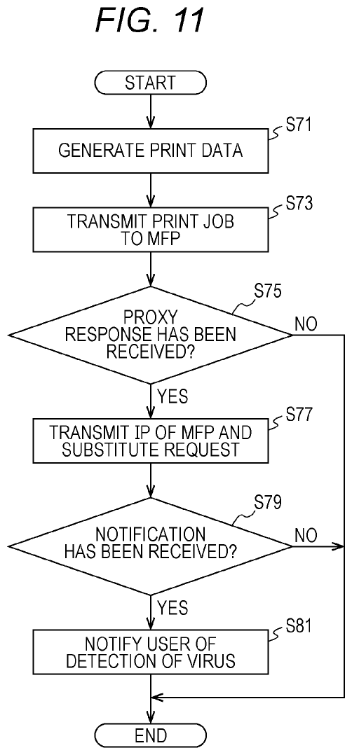

FIG. 11 is a flowchart illustrating an operation of the terminal 300 in one embodiment of the present invention.

Referring to FIG. 11, the CPU 301 generates a print job related to job data (S71), and transmits the generated print job to the MFP 100 (S73). Subsequently, the CPU 301 determines whether a proxy response has been received from the MFP 100 (S75).

When it is determined in step S75 that a proxy response has been received, the CPU 301 transmits the IP address of the MFP 100 and a virus scan substitute request for the job data to the server 200 (S77). Next, the CPU 301 determines whether a notification from the server 200 has been received (S79).

When it is determined in step S75 that no proxy response has been received (NO in S75), or when it is determined in step S79 that no notification has been received from the server 200 (NO in S79), the CPU 301 ends the process.

When it is determined in step S79 that the notification from the server 200 has been received (YES in S79), the CPU 301 notifies the user of the detection of the virus from the job data (S81) and ends the process.

### Effects of the Embodiment

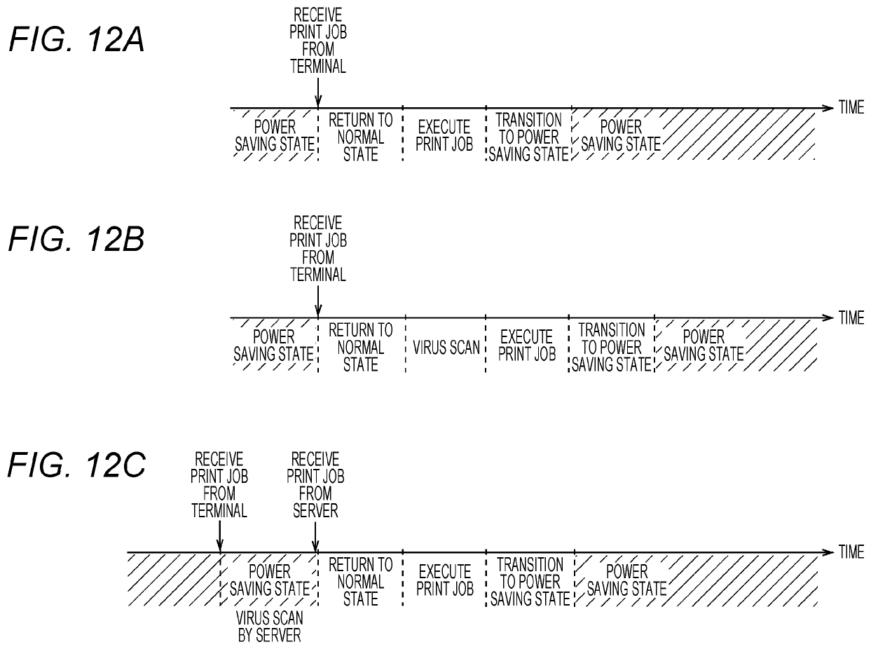

FIGS. 12A, 12B, and 12C are diagrams for explaining effects of one embodiment of the present invention.

Referring to FIGS. 12A, 12B, and 12C, an MFP that does not perform a virus scan on job data performs the operation illustrated in FIG. 12A. Specifically, the MFP returns from the power saving state to the normal state when receiving an execution instruction for a print job while being in the power saving state, executes the print job (print operation), and transitions from the normal state to the power saving state after completion of the print job.

An MFP that executes a virus scan on job data by itself regardless of the power supply state performs an operation illustrated in FIG. 12B. Specifically, the MFP returns to the normal state from the power saving state when receiving an execution instruction for a print job while being in the power saving state, and executes a virus scan on the job data. The MFP executes a print job when no virus is detected from the job data, and transitions from the normal state to the power saving state after completion of the print job. The MFP that executes a virus scan on job data regardless of the power supply state, will be in the power saving state for a period of time that is shorter than that of the MFP that does not execute a virus scan on job data, by the amount of time required for executing the virus scan.

The MFP 100 in the present embodiment performs an operation illustrated in FIG. 12C. Specifically, upon receiving an execution instruction for a print job from the terminal 300 while being in the power saving state, the MFP 100 stays in the power saving state and makes the server 200 serve as a substitute to execute a virus scan. The MFP 100 returns from the power saving state to the normal state upon receiving the execution instruction for a print job from the server 200, executes the print job, and transitions from the normal state to the power saving state after completion of the print job. The MFP 100 in the present embodiment stays in the power saving state for a longer period of time than that of the MFP that executes a virus scan on job data by itself regardless of the power supply state.

In the present embodiment, when the MFP 100 receives a print job, the MFP 100 or a virus scan substitute apparatus performs a virus scan on the job data. As a result, with the administrator controlling the update frequency of the definition files of the MFP 100 and the apparatus serving as a virus scan substitute and the enforcement policy related to virus scans, reliability of virus scans can be prevented from being decreased, whereby the security of the image processing system can be guaranteed.

In addition, when the MFP 100 is in the power saving state, the apparatus serving as a virus scan substitute executes a virus scan. Thus, by executing a virus scan on the job data by the host apparatus, the time period during which the MFP 100 staying in the power saving state can be prevented from being shortened. Thus, the deterioration of the power saving effect of the MFP 100 can be suppressed.

### Others

The above-described embodiments and modifications can be combined as appropriate.

The processing in the above-described embodiments may be performed by software or by using a hardware circuit. It is also possible to provide a program for executing the processing in the above-described embodiment, and record the program on a recording medium such as a CD-ROM, flexible disk, hard disk, ROM, RAM, memory card, and the like. The program is executed by a computer such as a CPU. The program may be downloaded to the apparatus via a communication line such as the Internet.

Although embodiments of the present invention have been described and illustrated in detail, the disclosed embodiments are made for purposes of illustration and example only and not limitation. The scope of the present invention should be interpreted not by terms of the above description but by terms of the appended claims, and is intended to include any modification within the meaning and scope equivalent to the claims

What is claimed is:

1. An image processing system comprising:
an image processing apparatus that has a virus scan function;
a terminal; and
an information processing apparatus that has a virus scan function, the image processing apparatus, the terminal, and the information processing apparatus communicating with each other, wherein
the image processing apparatus includes:
a first hardware processor that:
transmits to the terminal, when job data is received from the terminal in a power saving state in which power consumption is lower than in a normal state, information identifying the image processing apparatus and a virus scan substitute request for the job data for executing a virus scan in the information processing apparatus; and
causes returning from the power saving state to the normal state, when an execution instruction for a job related to the job data with predetermined information added is received in the power saving state, and
the information processing apparatus includes:
a second hardware processor that:
performs the virus scan on the job data when the information identifying the image processing apparatus and the virus scan substitute request for the job data are received from the terminal; and
transmits, to the image processing apparatus, the execution instruction for the job related to the job data with the predetermined information added when no virus is detected from the job data as a result of the virus scan by the second hardware processor.

2. The image processing system according to claim 1, wherein the job execution instruction related to the job data is a print job execution instruction for printing the job data.

3. The image processing system according to claim 1, wherein the terminal includes a third hardware processor that, when the information identifying the image processing apparatus and the virus scan substitute request for the job data in the information processing apparatus are received from the image processing apparatus, transmits the information identifying the image processing apparatus to the information processing apparatus and requests the information processing apparatus to serve as a substitute to execute the virus scan on the job data.

4. The image processing system according to claim 1, wherein in the image processing apparatus, the first hardware processor further executes the job related to the job data without performing the virus scan on the job data, after the returning from the power saving state to the normal state has been achieved by the first hardware processor.

5. The image processing system according to claim 1, wherein the job data is generated by the terminal.

6. The image processing system according to claim 1, wherein
the second hardware processor transmits to the image processing apparatus, when no virus is detected from the job data as a result of the virus scan by the second hardware processor, an execution instruction for a job related to the job data with information identifying the information processing apparatus added as the predetermined information, and
the first hardware processor causes the returning from the power saving state to the normal state when the execution instruction for the job related to the job data with the information identifying the information processing apparatus added is received in the power saving state.

7. The image processing system according to claim 1, wherein
the second hardware processor transmits to the image processing apparatus, the execution instruction for the job related to the job data with information indicating completion of the virus scan added as the predetermined information, when no virus is detected from the job data as a result of the virus scan by the second hardware processor, and
the first hardware processor causes the return from the power saving state to the normal state, when the execution instruction for the job related to the job data with the information indicating completion of the virus scan added is received in the power saving state.

8. The image processing system according to claim 1, wherein the information processing apparatus is connected to a local network line to which the image processing apparatus is connected, via a wide area network line.

9. The image processing system according to claim 1, wherein the information processing apparatus is another image processing apparatus connected to a local network line to which the image processing apparatus is connected, without passing through a wide area network line.

10. The image processing system according to claim 1, wherein
in the information processing apparatus,
the second hardware processor notifies, when virus is detected from the job data as a result of the virus scan by the second hardware processor, the terminal of the detection of the virus from the job data, and
the second hardware processor notifies, upon receiving an inquiry from the image processing apparatus when virus is detected from the job data as a result of the virus scan by the second hardware processor, the image processing apparatus of the result of the virus scan by the second hardware processor, and
in the image processing apparatus,
the first hardware processor issues the inquiry to the information processing apparatus, when the job data is received from the terminal in the power saving state and the returning from the power saving state to the normal state occurs before the execution instruction of the job related to the job data with the predetermined information added is received, and
the first hardware processor issues, when being notified of the result of the virus scan by the second hardware processor from the information processing apparatus, a notification on the result of the virus scan by the second hardware processor, on the image processing apparatus.

11. The image processing system according to claim 10, wherein
in the information processing apparatus,
the second hardware processor requests the image processing apparatus to return from the power saving state to the normal state, when virus is detected from the job data as a result of the virus scan by the second hardware processor but the second hardware processor is incapable of notifying the terminal of the detection of the virus, and
the second hardware processor notifies the image processing apparatus of the detection of the virus from the job data after the image processing apparatus has returned to the normal state.

12. The image processing system according to claim 1, wherein in the information processing apparatus, when the information identifying the image processing apparatus and the virus scan substitute request for the job data are received from the terminal and the second hardware processor is executing virus scan on another job data, the second hardware processor further transfers the information identifying the image processing apparatus and the virus scan substitute request for the job data to an apparatus having a virus scan function other than the image processing apparatus.

13. An image processing apparatus that has a virus scan function and communicates with a terminal and an information processing apparatus that has a virus scan function, the image processing apparatus comprising:
a first hardware processor that:
transmits to the terminal, when job data is received from the terminal in a power saving state in which power consumption is lower than in a normal state, information identifying the image processing apparatus and a virus scan substitute request for the job data in the information processing apparatus; and
causes returning from the power saving state to the normal state, when an execution instruction for a job related to the job data with predetermined information added is received in the power saving state.

14. A non-transitory recording medium storing a computer readable control program for an image processing apparatus that has a virus scan function and communicates with a terminal and an information processing apparatus that has a virus scan function, the computer readable control program causing a computer to execute:
transmitting to the terminal, when job data is received from the terminal in a power saving state in which power consumption is lower than in a normal state, information identifying the image processing apparatus and a virus scan substitute request for the job data in the information processing apparatus; and
causing returning from the power saving state to the normal state, when an execution instruction for a job related to the job data with predetermined information added is received in the power saving state.

15. An information processing apparatus that has a virus scan function and communicates with a terminal and an image processing apparatus that has a virus scan function, the information processing apparatus comprising:
a second hardware processor that:
performs a virus scan on job data when information identifying the image processing apparatus and a virus scan substitute request for the job data are received from the terminal; and
transmits, to the image processing apparatus, an execution instruction for a job related to job data with predetermined information added when no virus is detected from the job data as a result of the virus scan by the second hardware processor.

16. A non-transitory recording medium storing a computer readable control program for an information processing apparatus that has a virus scan function and communicates with a terminal and an image processing apparatus that has a virus scan function, the computer readable control program causing a computer to execute:
performing a virus scan on job data when the information identifying the image processing apparatus and a virus scan substitute request for the job data are received from the terminal; and
transmitting an execution instruction for a job related to the job data with predetermined information added to the image processing apparatus when no virus is detected from the job data as a result of the virus scan by the performing.

17. A non-transitory recording medium storing a computer readable control program for a terminal that communicates with an image processing apparatus that has a virus scan function and an information processing apparatus that has a virus scan function, the computer readable control program causing a computer to execute:
when information identifying the image processing apparatus and a virus scan substitute request for job data in the information processing apparatus are received from the image processing apparatus after the job data is transmitted to the image processing apparatus, transmitting the information identifying the image processing apparatus to the information processing apparatus, and requesting the information processing apparatus to serve as a substitute to execute the virus scan on the job data.
